(19) United States
(12) Patent Application Publication
(10) Pub. No.: US 2008/0017508 A1
(43) Pub. Date: Jan. 24, 2008

(54) Non-contact type single side probe structure

(75) Inventors: Tak Eun, Gyeonggi-do (KR); Seong Jin Kim, Seoul (KR)

Correspondence Address: OLIFF & BERRIDGE, PLC, P.O. BOX 320850, ALEXANDRIA, VA, 22320-4850, US

(73) Assignee: MICROINSPECTION, INC., SEOUL (KR)

(21) Appl. No.: 11/826,143

(22) Filed: Jul. 12, 2007

(30) Foreign Application Priority Data
Jul. 20, 2006 (KR) 2006-068232

(51) Int. Cl. G01N 27/403

(52) U.S. Cl. 204/400

(57) ABSTRACT

A non-contact type single side probe structure, in which a plurality of insulating films and conductive films are repeatedly stacked, includes probe electrodes formed at an inner conductive film portion of the cross-section of the structure and a guard portion formed at an outer conductive film portion surrounding the probe electrodes. Accordingly, it is possible to form the probe electrodes to have the thickness of the conductive films corresponding to a pitch of a pattern electrode, thereby detecting open and short circuit in a miniaturized pattern electrode. The cross-section used as a probe is spaced at a specified distance or further from contact holes, thereby having a high resistance to noises.

### BACKGROUND OF THE INVENTION

1. Field of the Invention

The present invention relates to a non-contact type single side probe structure, and more particularly to a non-contact type single side probe structure in which a plurality of insulating films and a plurality of conductive films are repeatedly stacked, the structure including probe electrodes formed at an inner conductive film portion of the cross-section of the structure and a guard portion formed at an outer conductive film portion of the cross-section, capable of forming the probe electrodes to have the thickness of the conductive films corresponding to a pitch of a pattern electrode, thereby detecting open and short circuit in a miniaturized pattern electrode.

2. Description of the Related Art

Generally, open and short circuit in a multi-line cable such as data transmission lines are detected by measuring a resistance between both ends of the cable after each line is separated from the other lines. Accordingly, two or more operators are necessarily required. In case of the cable including a large number of lines, occasionally, a line number is lost and the detection should be repeated, thereby lowering detection reliability and increasing the operation time.

Further, as shown in FIG. 1, in a flat plate display device 10 (e.g., LCD and PDP), open and short circuit may be detected by applying current to one end of each pattern electrode 15 and measuring a voltage at the other end of the corresponding pattern electrode 15. Also, the open and short circuit may be detected by checking conducting lines with a microscope and the like. In FIG. 1, reference numeral 20 denotes a probe block, and reference numeral 30 denotes a pin probe.

Accordingly, at least two probes are required in order to detect the open and short circuit in a single pattern electrode. Thus, a number of probes are required and the cost is increased. Further, a long pattern electrode requires two or more operators for the measurement at different positions, thereby taking a lot of time and man power.

Further, in case of a contact type probe, since the probe is in press-contact with the pattern electrode, a contact error may occur. Further, a scratch may be generated on the pattern electrode serving as a measurement target, thereby causing another error.

To solve the above-mentioned problems, a non-contact type single side probe, wherein an exciter electrode and a sensor electrode serving as non-contact probe electrodes are configured as a single module, is applied to an inspection apparatus to detect open and short circuit at one end of the pattern electrode while the probe is not in contact with the pattern electrode.

FIG. 2 shows a cross-section of the non-contact type single side probe. As shown in FIG. 2, an exciter electrode 41 and a sensor electrode 42 serving as probe electrodes are disposed at an inner portion of the cross-section and a guard portion 50 is disposed at an outer portion of the cross-section to be electrically grounded, thereby preventing an influence due to outside noises and preventing signals supplied to the probe electrodes from leaking into the outside.

Along with the trend of miniaturized and multi-pin pattern electrodes, the probe should be miniaturized to detect the open and short circuit in the pattern electrode. However, since the probe electrodes and the guard portion 50 surrounding the probe electrodes should be formed in the conventional structure, it is difficult to apply the conventional structure to the miniaturized pattern.

### SUMMARY OF THE INVENTION

Therefore, the present invention has been made in view of the above problems, and it is an object of the present invention to provide a non-contact type single side probe structure in which a plurality of insulating films and a plurality of conductive films are repeatedly stacked, the structure including probe electrodes formed at an inner conductive film portion of the cross-section of the structure and a guard portion formed at an outer conductive film portion of the cross-section, capable of forming the probe electrodes to have the thickness of the conductive films corresponding to a pitch of a pattern electrode, thereby detecting open and short circuit in a miniaturized pattern electrode.

In accordance with an aspect of the present invention, there is provided a non-contact type single side probe structure comprising: a probe electrode formed at an inner conductive film portion of a cross-section of a plurality of insulating films and conductive films that are repeatedly stacked; a guard portion formed at an outer conductive film portion of the cross-section, the outer conductive film portion surrounding the probe electrode; and contact holes for interfacing with the probe electrode and the guard portion.

Preferably, the insulating films and the conductive films are printed circuit boards (PCBs) or flexible printed circuit boards (FPCBs).

Preferably, the insulating films and the conductive films are thin films formed by deposition.

In accordance with another aspect of the present invention, there is provided a non-contact type single side probe structure comprising: first layers each including an insulating film and a conductive film disposed on the insulating film to form a guard portion; at least one second layer including an insulating film and a conductive film disposed on the insulating film to have a probe electrode and a guard portion that are patterned thereon; guard contact holes for interfacing with the guard portion; and electrode contact holes for interfacing with the probe electrodes, wherein a cross-section of the first layer, the second layer and the first layer that are sequentially stacked is formed as a probe.

Preferably, the probe electrode is patterned into a plurality of electrodes in the second layer.

Preferably, the probe electrode is thickened by depositing a plurality of the second layers.

Preferably, the insulating films and the conductive films are printed circuit boards (PCBs) or flexible printed circuit boards (FPCBs).

Preferably, the insulating films and the conductive films are thin films formed by deposition.

As described above, in the non-contact type single side probe structure according to the present invention, a plurality of insulating films and a plurality of conductive films are repeatedly stacked, and the structure includes probe electrodes formed at an inner conductive film portion of the cross-section of the structure and a guard portion formed at an outer conductive film portion of the cross-section. Accordingly, it is possible to form the probe electrodes to have the thickness of the conductive films corresponding to a pitch of a pattern electrode, thereby detecting open and short circuit in a miniaturized pattern electrode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram for explaining a method of detecting open and short circuit in a general pattern electrode;

FIG. 2 shows a plan view of a general non-contact type single side probe;

FIG. 3 shows a perspective view of a non-contact type single side probe according to the present invention;

FIGS. 4A and 4B illustrate respective layers included in the non-contact type single side probe according to the present invention; and

FIG. 5 illustrates another example of the non-contact type single side probe according to the present invention.

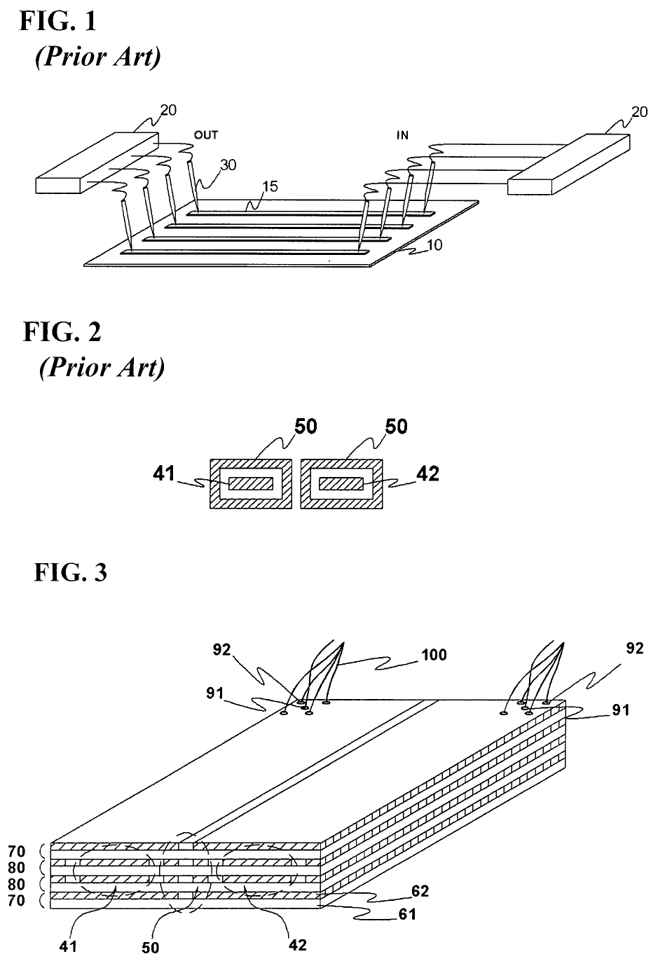

### DETAILED DESCRIPTION OF THE PREFERRED EMBODIMENTS

Hereinafter, a preferred embodiment of the present invention will be described with reference to accompanying drawings, in which like reference numerals designate like parts having practically the same functions as the conventional structure.

FIG. 3 shows a non-contact type single side probe structure according to the present invention.

As shown in FIG. 3, a plurality of insulating films 61 and a plurality of conductive films 62 are repeatedly stacked. An exciter electrode 41 and a sensor electrode 42 serving as probe electrodes are formed at an inner conductive film portion of the cross-section of the structure. A guard portion 50 is formed at an outer conductive film portion surrounding the probe electrodes. Accordingly, the entire profile is similar to the non-contact type single side probe structure shown in FIG. 2. That is, the guard portion 50 is formed at the outer portion having a pitch corresponding to the thickness of the insulating film 61 and the conductive film 62. The exciter electrode 41 and the sensor electrode 42 serving as probe electrodes are formed inside the guard portion 50.

Further, cables 100 are provided to pass through electrode contact holes 91 and guard contact holes 92. The probe electrodes 41 and 42 and the guard portion 50 interface with an inspection apparatus through the cables 100 such that the exciting and sensing are performed through the probe electrodes 41 and 42 and the guard portion 50 is electrically grounded.

In this case, the insulating films 61 and the conductive films 62 may be configured by stacking printed circuit boards (PCBs) or flexible printed circuit boards (FPCBs). In order to form the probe electrodes having finer lines, the insulating films 61 and the conductive films 62 may be formed by depositing thin films according to a semiconductor manufacturing process.

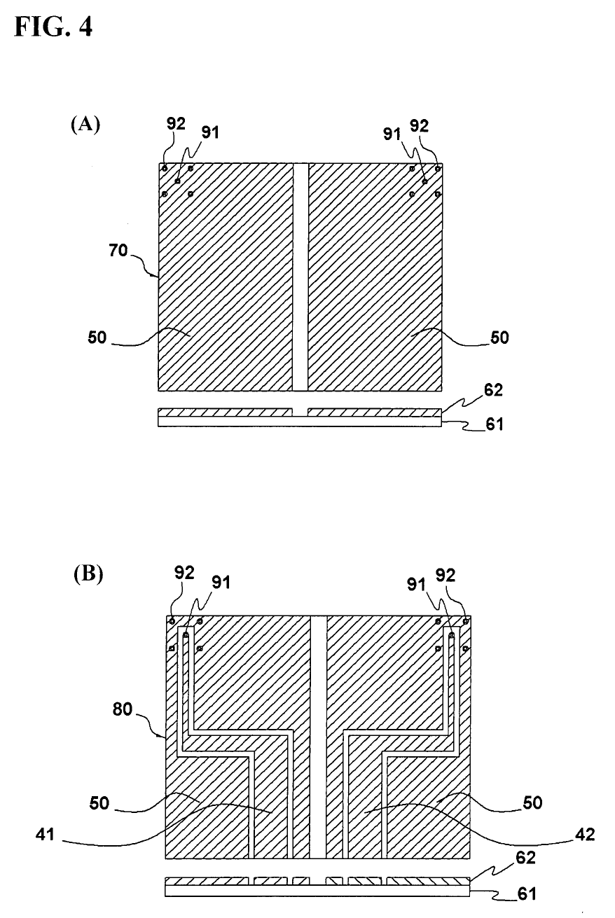

FIGS. 4A and 4B shows layers included in the non-contact type single side probe according to the present invention.

As shown in FIG. 4A, first layers 70 are disposed at upper and lower portions of the guard portion 50 of the probe. Each of the first layers 70 includes the insulating film 61 and the conductive film 62 formed on the insulating film 61. The first layer 70 further includes the electrode contact holes 91 for interfacing with the exciter electrode 41 and the sensor electrode 42 and the guard contact holes 92 for interfacing with the guard portion 50.

As shown in FIG. 4B, each of second layers 80 includes the insulating film 61 and the conductive film 62 formed on the insulating film 61, wherein the exciter electrode 41 and the sensor electrode 42 serving as probe electrodes and the guard portion 50 are patterned on the conductive film 62. The second layer 80 further includes the electrode contact holes 91 for interfacing with the exciter electrode 41 and the sensor electrode 42 and the guard contact holes 92 for interfacing with the guard portion 50.

As shown in FIG. 3, the probe is formed by stacking the first layer 70, the second layer 80, the second layer 80 and the first layer 70 from bottom top.

In this case, the exciter electrode 41 and the sensor electrode 42 serving as probe electrodes may be thickened by repeatedly stacking the second layers 80.

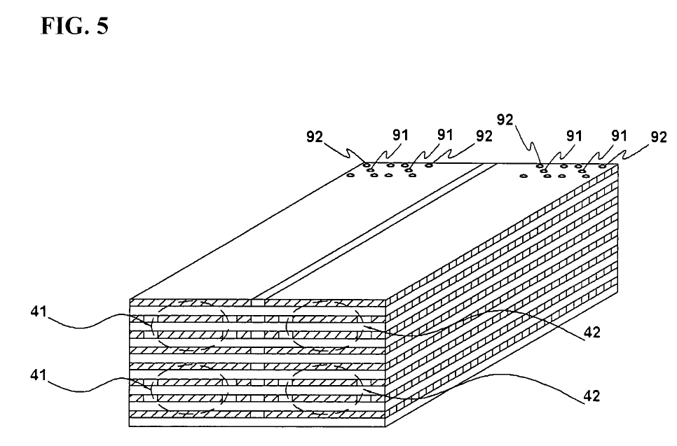

Meanwhile, as shown in FIG. 5, the exciter electrodes 41 and the sensor electrodes 42 may be formed in a double structure and the electrode contact holes 91 and the guard contact holes 92 are respectively connected to the exciter electrodes 41 and the sensor electrodes 42, thereby forming a single module.

As described above, in the non-contact type single side probe structure according to the present invention, a plurality of insulating films and a plurality of conductive films are repeatedly stacked, and the structure includes probe electrodes formed at an inner conductive film portion of the cross-section of the structure and a guard portion formed at an outer conductive film portion of the cross-section. Accordingly, it is possible to form the probe electrodes to have the thickness of the conductive films corresponding to a pitch of a pattern electrode, thereby detecting open and short circuit in a miniaturized pattern electrode.

Further, in the non-contact type single side probe structure according to the present invention, the cross-section used as a probe is spaced at a specified distance or further from the contact holes, thereby having a high resistance to noises.

Further, in the non-contact type single side probe structure according to the present invention the insulating films and the conductive films may be formed by depositing thin films according to a semiconductor manufacturing process. Thus, it can be applied to a miniaturized pattern electrode.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A non-contact type single side probe structure comprising:
a probe electrode formed at an inner conductive film portion of a cross-section of a plurality of insulating films and conductive films that are repeatedly stacked;
a guard portion formed at an outer conductive film portion of the cross-section, the outer conductive film portion surrounding the probe electrode; and
contact holes for interfacing with the probe electrode and the guard portion.

2. The non-contact type single side probe structure according to claim 1, wherein the insulating films and the conductive films are printed circuit boards (PCBs) or flexible printed circuit boards (FPCBs).

3. The non-contact type single side probe structure according to claim 1, wherein the insulating films and the conductive films are thin films formed by deposition.

4. A non-contact type single side probe structure comprising:
first layers each including an insulating film and a conductive film disposed on the insulating film to form a guard portion;
at least one second layer including an insulating film and a conductive film disposed on the insulating film to have a probe electrode and a guard portion that are patterned thereon;
guard contact holes for interfacing with the guard portion; and
electrode contact holes for interfacing with the probe electrodes,
wherein a cross-section of the first layer, the second layer and the first layer that are sequentially stacked is formed as a probe.

5. The non-contact type single side probe structure according to claim 4, wherein the probe electrode is patterned into a plurality of electrodes in the second layer.

6. The non-contact type single side probe structure according to claim 4, wherein the probe electrode is thickened by depositing a plurality of the second layers.

7. The non-contact type single side probe structure according to claim 4, wherein the insulating films and the conductive films are printed circuit boards (PCBs) or flexible printed circuit boards (FPCBs).

8. The non-contact type single side probe structure according to claim 4, wherein the insulating films and the conductive films are thin films formed by deposition.
